(19) United States
(12) Patent Application Publication
(10) Pub. No.: US 2014/0022471 A1
(43) Pub. Date: Jan. 23, 2014

(54) LIQUID CRYSTAL DISPLAY DEVICE

(71) Applicant: Samsung Display Co., Ltd., Yongin-city (KR)

(72) Inventors: Dong Gyu Kim, Yongin-city (KR); Sang Soo Kim, Yongin-city (KR)

(21) Appl. No.: 13/939,499

(22) Filed: Jul. 11, 2013

(30) Foreign Application Priority Data
Jul. 23, 2012 (KR) 10-2012-0080014

(51) Int. Cl. G02F 1/1362

(52) U.S. Cl. CPC G02F 1/136213
USPC 349/15

(57) ABSTRACT

A liquid crystal display device based on a simultaneous writing method is provided. The liquid crystal display device includes a liquid crystal panel including a gate line, a data line intersecting the gate line and a plurality of pixels, wherein each of the plurality of pixels includes a transistor having a gate connected to the gate line, a source connected to the data line and a drain connected to a first node, a switch having one end connected to the first node and another end connected to a second node, a first capacitor having one end connected to the first node, and a liquid crystal capacitor having one end connected to the second node.

### CROSS-REFERENCE TO RELATED APPLICATIONS

This application claims priority from Korean Patent Application No. 10-2012-0080014 filed on Jul. 23, 2012 in the Korean Intellectual Property Office, the disclosure of which is incorporated herein by reference in its entirety.

### BACKGROUND

1. Field

The present disclosure relates to a liquid crystal display device, and more particularly, to a liquid crystal display device based on a simultaneous writing method.

2. Description of the Related Technology

A liquid crystal display device includes a liquid crystal layer containing liquid crystal particles. According to the voltage applied to the liquid crystal layer, arrangement of liquid crystal particles varies, and the light transmittance of the liquid crystal layer varies accordingly. The liquid crystal display device generally includes a plurality of pixel areas and may display a desired image by controlling the voltage applied to the liquid crystal layer included in each of the plurality of pixel areas. As an example of a voltage application method, there is a progressive writing method in which a voltage is applied to a plurality of pixels included in a liquid crystal display device. According to the progressive writing method, a voltage is applied to a plurality of pixels arranged in a matrix configuration in a column order.

### SUMMARY OF CERTAIN INVENTIVE ASPECTS

The present invention provides a liquid crystal display device which can improve display quality of a stereoscopic image.

The present invention also provides a liquid crystal display device which can improve brightness of a stereoscopic image.

The above and other objects of the present invention will be described in or be apparent from the following description of certain embodiments.

According to an aspect of the present invention, there is provided a liquid crystal display device including a liquid crystal panel including a gate line, a data line intersecting the gate line and a plurality of pixels, wherein each of the plurality of pixels includes a transistor having a gate connected to the gate line, a source connected to the data line and a drain connected to a first node, a switch having one end connected to the first node and another end connected to a second node, a first capacitor having one end connected to the first node, and a liquid crystal capacitor having one end connected to the second node.

According to another aspect of the present invention, there is provided a liquid crystal display device including a liquid crystal panel including a gate line, a data line intersecting the gate line, a common voltage line to which a common voltage is configured to be applied and a plurality of pixels, wherein each of the plurality of pixels comprises: a transistor having a gate connected to the gate line, a source connected to the data line and a drain connected to a first node, a first switch having one end connected to the first node and another end connected to a second node, a first capacitor having one end connected to the first node, a second switch having one end connected to the second node and another end connected to the common voltage line, and a liquid crystal capacitor having one end connected to the second node.

The embodiments of the present invention may provide a liquid crystal display device which can improve display quality of a stereoscopic image.

In addition, the embodiments of the present invention may provide a liquid crystal display device which can improve brightness of a stereoscopic image.

### BRIEF DESCRIPTION OF THE DRAWINGS

The above and other features and advantages of the present invention will become more apparent by describing in detail certain embodiments thereof with reference to the attached drawings in which:

FIG. 1 is a block diagram of a liquid crystal display device according to an embodiment of the present invention;

FIG. 2 is a circuit diagram of a pixel according to an embodiment of the present invention;

FIG. 3 is a graph illustrating a control signal, a gate signal and a gate signal according to an embodiment of the present invention;

FIG. 4 is a circuit diagram of a pixel according to another embodiment of the present invention;

FIG. 5 is a block diagram of a liquid crystal display device according to another embodiment of the present invention;

FIG. 6 is a circuit diagram of a pixel according to still another embodiment of the present invention;

FIG. 7 is a graph illustrating a control signal, a gate signal and a gate signal according to another embodiment of the present invention; and

FIG. 8 is a circuit diagram of a pixel according to still another embodiment of the present invention.

### DETAILED DESCRIPTION OF CERTAIN INVENTIVE EMBODIMENTS

The present invention will now be described more fully hereinafter with reference to the accompanying drawings, in which certain embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers generally indicate the same components throughout the specification. In the attached figures, the thickness of layers and regions may be exaggerated for clarity.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Hereinafter, the present invention will be described in further detail with reference to the accompanying drawings.

In order to implement stereoscopic three-dimensional (3D) image display, different images may be input to left and right eyes of a human. To this end, a shutter glass technique or a polarization technique may be employed. According to the shutter glass technique, a stereoscopic image viewer wears glasses having shutters attached thereto and a shutter member in the right eye of the glasses is operated to shut a right eye input when a display device displays a frame of a left eye image and a shutter member in the left eye of the glasses is operated to shut a left eye input when a display device displays a frame of a left eye image.

In a progressive writing based liquid crystal display device which displays a stereoscopic image in the shutter glass technique, when the left eye shutter is opened, a voltage for the left eye image may be input to pixels by column, and a voltage for the right eye image of the previous frame may be maintained at pixels to which a voltage for the left eye image has not yet been input. In this case, the left and right eye images may overlap each other, which is referred to as a crosstalk, or a difference in the brightness between top and bottom portions of a screen may occur, thereby deteriorating display quality.

In order to prevent deterioration of display quality, a period in which a backlight is turned off may be inserted between frames or a black image may be inserted between frames. In either case, the brightness of an image may be deteriorated.

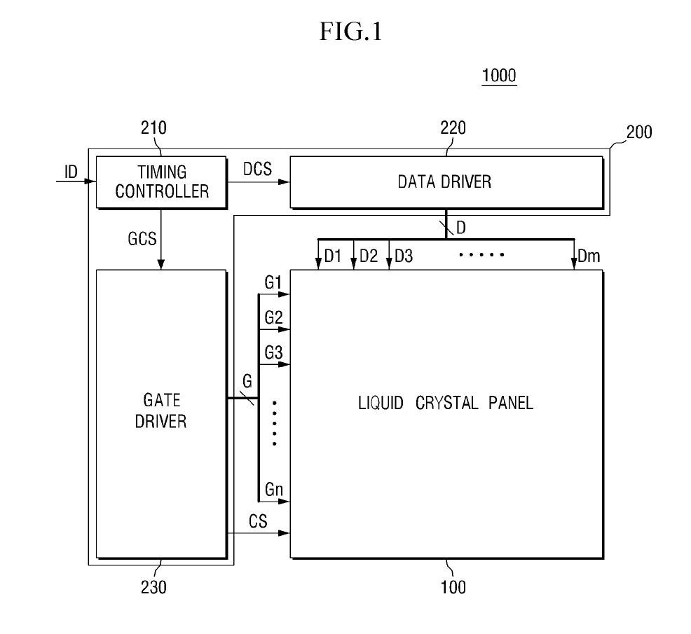

FIG. 1 is a block diagram of a liquid crystal display device according to an embodiment of the present invention;

FIG. 1 is a block diagram of a liquid crystal display device according to an embodiment of the present invention. Referring to FIG. 1, the liquid crystal display device 1000 according to an embodiment of the present invention includes a liquid crystal panel 100.

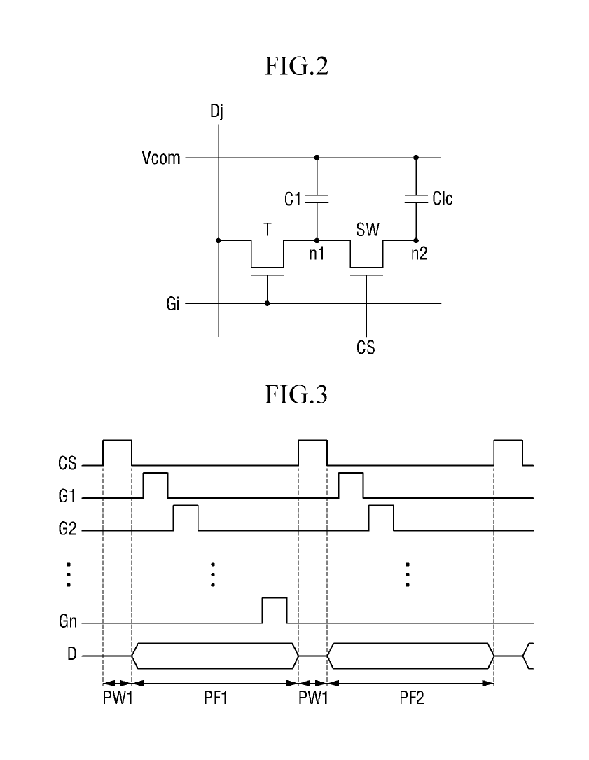

The liquid crystal panel 100 may receive a data signal D and a gate signal G from a driver 200 (described below) and may display an image corresponding to the received signals. The liquid crystal panel 100 may include data lines D1, D2, . . . and Dm to which the data signal D is applied, and gate lines G1, G2, . . . and Gn to which the gate signal G is applied. The data signal D and the gate signal G may be in the form of voltage. The liquid crystal panel 100 may include a plurality of pixels, which are defined by intersection areas of the data lines D1, D2, . . . and Dm and the gate lines G1, G2, . . . and Gn. Hereinafter, a pixel will be described in more detail with reference to FIG. 2.

FIG. 2 is a circuit diagram of a pixel according to an embodiment of the present invention.

Referring to FIG. 2, the pixel according to an embodiment of the present invention may include a transistor T, a first capacitor C1, a switch SW, a liquid crystal capacitor Clc and a common voltage line Vcom.

The transistor T has a gate connected to an ith gate line Gi, a source connected to a jth data line Dj, and a drain connected to a first node n1, where i is a natural number between 1 and n, and j is a natural number between 1 and m. The gate signal G may include a gate-on signal and a gate-off signal. When the gate-on signal is applied to the ith gate line Gi, the transistor T is turned on to transmit the data signal applied to the ith data line Di to the first node n1.

The first capacitor C1 may have one end connected to the first node n1. The first capacitor C1 may store the data signal, which is transmitted from the jth data line Dj by the transistor T, in the first node n1. The first capacitor C1 may have the other end connected to the common voltage line Vcom.

The switch SW may have one end connected to the first node n1 and the other end connected to a second node n2. The switch SW may be controlled to be on or off by a control signal CS, which may be generated from the driver 200. If the switch SW is on, the first node n1 and the second node n2 may be electrically connected to each other by the switch SW, and the data signal stored in the first capacitor C1 may be transmitted to the liquid crystal capacitor Clc. If the switch SW is off, the first node n1 and the second node n2 may be electrically disconnected from each other by the switch SW. In some embodiments, the switches SW of the plurality of pixels included in the liquid crystal panel 100 may be simultaneously turned on or off

If the switches SW of the plurality of pixels included in the liquid crystal panel 100 are simultaneously turned on or off, the data signal may be simultaneously applied to the liquid crystal capacitors Clc of the plurality of pixels. Therefore, the liquid crystal display device 1000 may be driven by a simultaneous writing method. In the liquid crystal display device 1000 driven by a simultaneous writing method, for example, in a case where a 3D image based on a shutter glass technique is displayed on the liquid crystal panel 100, when the left eye shutter is opened, the data signal of a frame corresponding to the left eye image is maintained at the liquid crystal capacitor Clc, while the data signal of a frame corresponding to the right eye image is not maintained at the liquid crystal capacitor Clc, thereby preventing crosstalk and uniformly maintaining brightness at top and bottom portions of a screen. In addition, high levels of the uniform brightness can be maintained at the top and bottom portions of the screen, thereby improving the brightness of the overall screen. Description about a case where the right eye shutter is opened is substantially the same as that about the case where the left eye shutter is opened.

The liquid crystal capacitor Clc may have one end connected to the second node n2 and the other end connected to the common voltage line Vcom. According to the voltage applied to the liquid crystal capacitor Clc, arrangement of liquid crystal particles contained in the liquid crystal panel 100 varies, and the light transmittance of the liquid crystal panel 100 may vary accordingly. If the switch SW is turned on, the data signal stored in the first capacitor C1 is transmitted to the liquid crystal capacitor Clc and stored therein. Thereafter, if the switch SW is turned off, the liquid crystal capacitor Clc may maintain the data signal stored therein.

A common voltage is applied to the common voltage line Vcom. The common voltage line Vcom may include a common electrode to which the common voltage contained in the liquid crystal panel is applied and other wirings.

Referring back to FIG. 1, the liquid crystal display device 1000 may further include the driver 200. The driver 200 may receive image data ID and may generate the data signal D, the gate signal G and the control signal CS to control the liquid crystal panel 100 to display an image.

Hereinafter, the data signal D, the gate signal G and the control signal CS according to an embodiment of the present invention will be described in detail with reference to FIG. 3. FIG. 3 is a graph illustrating a control signal, a gate signal and a gate signal according to an embodiment of the present invention.

Referring to FIG. 3, the driver 200 may control the control signal CS to turn on the switch SW during a first writing period PW1. FIG. 3 illustrates that the switch SW is turned on when the control signal CS is logic high, but aspects of the present invention are not limited thereto. If the switch SW is turned on during the first writing period PW1, the data signal stored in the first capacitor C1 may be transmitted to the liquid crystal capacitor Clc. The data signals stored in the first capacitor C1 in the plurality of pixels included in the liquid crystal panel 100 before the first writing period PW1 are collectively transmitted to the liquid crystal capacitor Clc, thereby simultaneously writing the data signals.

During the first writing period PW1, the data signal D may not be applied to the data lines D1, D2, . . . , and Dm. If the data signal D is not applied to the data lines D1, D2, . . . , and Dm during the first writing period PW1, it is possible to prevent the first capacitor C1 and the liquid crystal capacitor Clc from being affected by noises generated by the data signal D.

During a first display period PF1, the driver 200 may control the control signal CS to turn on the switch SW. During the first display period PF1, the liquid crystal capacitor Clc may maintain the data signal transmitted thereto during the first writing period PW1, and the liquid crystal panel 100 may maintain an image corresponding to the data signal. The image displayed on the liquid crystal panel 100 during the first display period PF1 may be an image corresponding to a first frame. In some embodiments, the liquid crystal panel 100 may display a stereoscopic image, and the first frame may be a frame corresponding to the left eye or the right eye.

During the first display period PF1, the gate-on signal may be applied to the first to nth gate lines G1, G2, . . . , and Gn. The gate-on signal may be a gate signal at logic high. While FIG. 3 illustrates the gate-on signal is progressively applied to the first to ith gate lines G1, G2, . . . , and Gn, the order of applying the gate-on signal is not limited thereto. Rather, the order of applying the gate-on signal may vary according to different embodiments.

During the first display period PF1, the data signal D may be applied to data lines D1, D2, . . . , and Dm. The data signal D1 may be stored in the first capacitor C1 of the pixel to which the gate-on signal is applied. During the first display period PF1, the data signal D applied to the lines D1, D2, . . . , and Dm may be a data signal corresponding to an image of the second frame following the first frame. In a case where the first frame is a left eye image, the second frame may be a right eye image, and vice versa.

During the first display period PF1, the liquid crystal panel 100 may store in the first capacitor C1 the data signal of the image corresponding to the second frame following the first frame while displaying the image corresponding to the first frame.

During a second writing period PW2, the data signal corresponding to the second frame stored in the first capacitor C1 may be transmitted to the liquid crystal capacitor Clc. Description about the other details of the second writing period PW2 is substantially the same as that about the first writing period PW1.

During a second display period PF2, the liquid crystal panel 100 may display the image corresponding to the second frame and may store the data signal corresponding to a third frame following the second frame in the first capacitor C1. Description about the other details of the second display period PF2 is substantially the same as that about the first display period PF1.

Referring again to FIG. 1, the driver 200 may include a timing controller 210, a data driver 220 and a gate driver 230.

The timing controller 210 may receive the image data ID and may generate a data control signal DCS and a gate control signal GCS. The data control signal DCS may be transmitted to the data driver 220 and may control the data signal D in the form of voltage corresponding to the image data ID. The gate control signal GCS may be transmitted to the gate driver 230 and may control the gate driver 230 to generate the gate signal G and the control signal CS.

The data driver 220 may receive the data control signal DCS and may generate the data signal D corresponding thereto. The data signal D may be applied to the data lines D1, D2, . . . , and Dm.

The gate driver 230 may receive the gate control signal GCS and may generate the gate signal G and the control signal CS. The gate signal G may be applied to the gate lines G1, G2, . . . , and Gn. FIG. 1 illustrates that the control signal CS is output from the gate driver G, but aspects of the present invention are not limited thereto. According to some embodiments, the control signal CS may be output from the timing controller 210 or the data driver 220. Alternatively, the driver 200 may include a separate element for outputting the control signal CS.

FIG. 1 illustrates that the driver 200 is divided into the timing controller 210, the data driver 220 and the gate driver 230. In some embodiments, the driver 200 may not be divided into the timing controller 210, the data driver 220 and the gate driver 230 but may be formed of a single element.

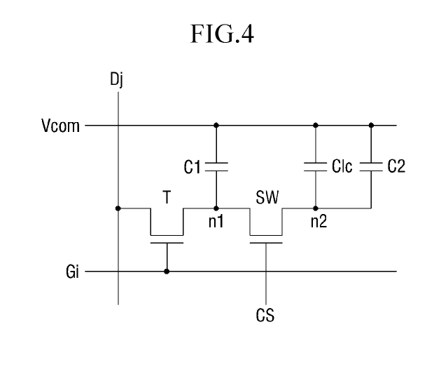

Hereinafter, another embodiment of the present invention will be described with reference to FIG. 4. FIG. 4 is a circuit diagram of a pixel according to another embodiment of the present invention.

Referring to FIG. 4, the pixel according to another embodiment of the present invention is different from the pixel shown in FIG. 2 in that it further includes a second capacitor C2. The second capacitor C2 may have one end connected to the second node n2 and the other end connected to the common voltage line Vcom. The second capacitor C2 may increase capacitance between the second node n2 and the common voltage line Vcom to allow the data signal to be effectively maintained in a liquid crystal capacitor Clc during display periods PF1 and PF2. The liquid crystal display device according to another embodiment of the present invention may be substantially the same as the liquid crystal display device 1000 shown in FIGS. 1 to 3, except for the foregoing aspects.

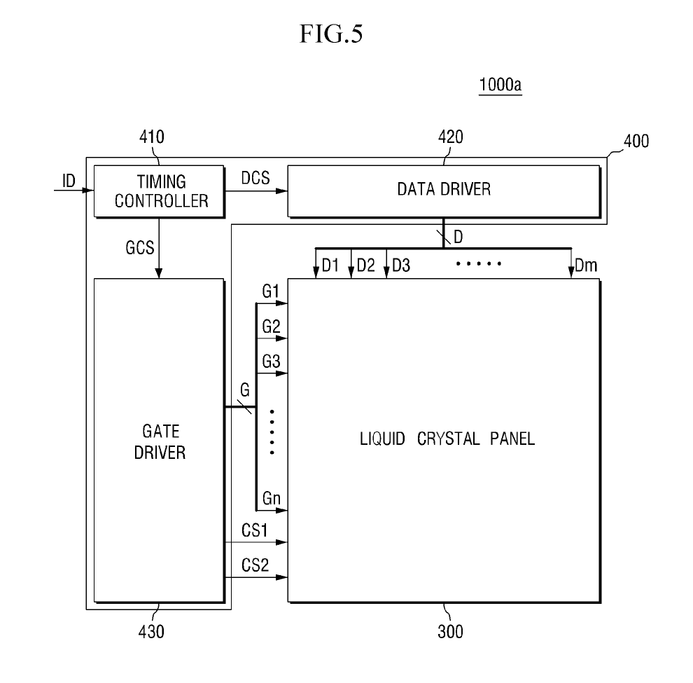

Hereinafter, another embodiment of the present invention will be described with reference to FIGS. 5 to 7.

FIG. 5 is a block diagram of a liquid crystal display device according to another embodiment of the present invention.

Referring to FIG. 5, the liquid crystal display device 1000a according to another embodiment of the present invention may include a liquid crystal panel 300.

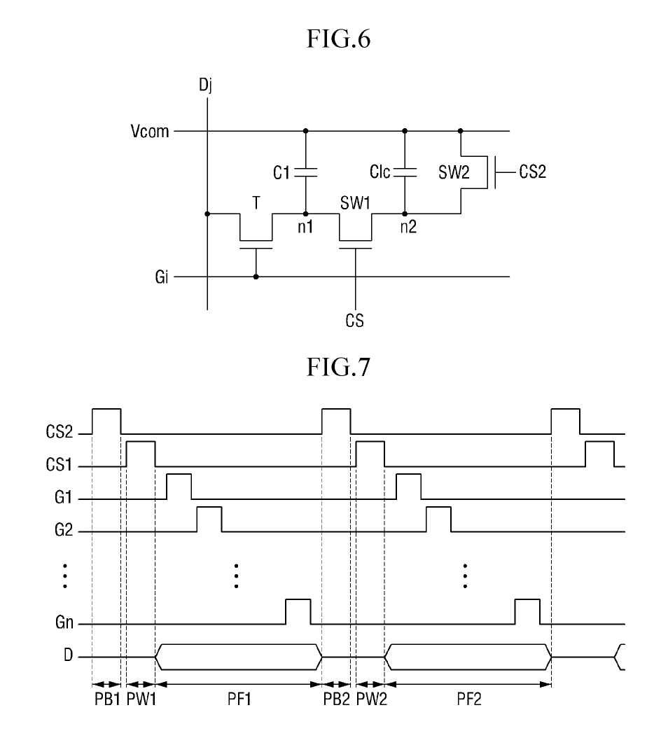

The liquid crystal panel 300 may receive a data signal D and a gate signal G from a driver 400 (described below) and may display an image corresponding thereto. The liquid crystal panel 300 may include a plurality of data lines D1, D2, . . . and Dm to which the data signal D is applied and a plurality of gate lines G1, G2, . . . and Gn to which the gate signal G is applied. The liquid crystal panel 300 may include a plurality of pixels, which may be defined by intersection areas of the data lines D1, D2, . . . and Dm and the gate lines G1, G2, . . . and Gn. Hereinafter, the pixel will be described in more detail with reference to FIG. 6.

FIG. 6 is a circuit diagram of a pixel according to still another embodiment of the present invention.

Referring to FIG. 6, the pixel according to still another embodiment of the present invention may include a transistor T, a first capacitor C1, a first switch SW1, a liquid crystal capacitor Clc, a common voltage line Vcom and a second switch SW2.

The transistor T, the first capacitor C1, the liquid crystal capacitor Clc and the common voltage line Vcom are substantially the same as those shown in FIG. 2.

The first switch SW1 and a first control signal CS1 may be substantially the same as those shown in FIG. 2.

The second switch SW2 may have one end connected to the second node n2 and the other connected to the common voltage line Vcom. The second switch SW2 may be controlled to be on or off by a second control signal CS2. If the second switch SW2 is turned on, the second node n2 and the common voltage line Vcom may be electrically connected by the second switch SW2. If the second node n2 and the common voltage line Vcom are electrically connected, a potential difference between opposite ends of the liquid crystal capacitor Clc becomes zero, so that the pixel may have the minimum light transmittance, thereby displaying a black pixel. The second switches SW2 of the plurality of pixels included in the liquid crystal panel 300 may be simultaneously turned on. In this case, the liquid crystal panel 300 may display a black image. If the second switch SW2 is turned off, the second node n2 and the common voltage line Vcom may be electrically disconnected by the second switch SW2.

Referring again to FIG. 5, the liquid crystal display device 1000a may further include a driver 400. The driver 400 may generate a data signal D, a gate signal G, a first control signal CS1 and a second control signal CS2 to supply the same to the liquid crystal panel 300. Hereinafter, the data signal D, the gate signal G, the first control signal CS1 and the second control signal CS2 will be described in more detail with reference to FIG. 7.

FIG. 7 is a graph illustrating a control signal, a gate signal and a gate signal according to another embodiment of the present invention.

Referring to FIG. 7, the driver 400 may control the second control signal CS2 to turn on the second switch SW2 during black periods PB1 and PB2. FIG. 7 illustrates that the second switch SW2 is turned on when the control signal CS is logic high, but aspects of the present invention are not limited thereto. During the black periods PB1 and PB2, the second switches SW2 of the plurality of pixels included in the liquid crystal panel 300 are all turned on, thereby allowing the liquid crystal panel 300 to display a black image.

The black periods PB1 and PB2, which follow display periods PF1 and PF2, may be arranged between writing periods PW1 and PW2. For example, the second black period PB2, which follows the first display period PF1, may be arranged between the first display period PF1 and the second writing period PW2. When the liquid crystal display device 1000a is driven by an inversion driving method, the polarity of a voltage corresponding to the data signal may be inverted each frame. Therefore, if the liquid crystal display device 1000a is driven by the inversion driving method, the polarity of the data signal stored in the liquid crystal capacitor Clc during the first display period PF1 may be opposite to the polarity of the data signal stored in the liquid crystal capacitor Clc during the second writing period PW2. If the second black period PB2 is arranged to follow the first display period PF1, a potential difference of the voltage applied to opposite ends of the liquid crystal capacitor Clc during the second black period PB2 rapidly swings to 0. Therefore, when the data signal having a polarity different from that during the first display period PF1 is applied to the liquid crystal capacitor Clc during the second writing period PW2, the liquid crystal capacitor Clc can be charged rapidly.

During the black periods PB1 and PB2, the gate-on signal may not be applied to the gate lines G1, G2, . . . , and Gn, the data signal may not be applied to the data lines D1, D2, . . . , and Dm, and the first switch SW1 may be at a turned-off state.

During the display periods PF1 and PF2 and the writing periods PW1 and PW2, the second switch SW2 may be at a turned-off state. Description about the other details of the display periods PF1 and PF2 and the writing periods PW1 and PW2 is substantially the same as that in FIG. 3.

Referring again to FIG. 5, the driver 400 may include a timing controller 410, a data driver 420 and a gate driver 430. FIG. 5 illustrates that the gate driver 430 generates the second control signal CS2, but aspects of the present invention are not limited thereto. In some embodiments, the second control signal CS2 may be generated from the timing controller 410 or the data driver 420.

Description about the other details of the driver 400 is substantially the same as that about the driver 200 shown in FIG. 1.

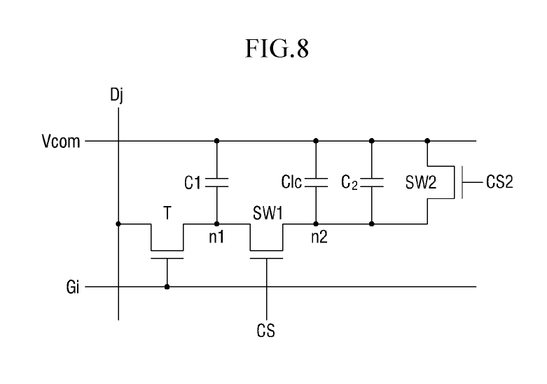

Hereinafter, another embodiment of the present invention will be described with reference to FIG. 8. FIG. 8 is a circuit diagram of a pixel according to still another embodiment of the present invention.

Referring to FIG. 8, the pixel according to still another embodiment of the present invention may include a transistor T, a first capacitor C1, a second capacitor C2, a first switch SW1, a liquid crystal capacitor Clc, a common voltage line Vcom and a second switch SW2.

The transistor T, the first capacitor C1, the first switch SW1, the liquid crystal capacitor Clc, the common voltage line Vcom and the second switch SW2 are substantially the same as those shown in FIG. 6.

The second capacitor C2 may have one end connected to the second node n2 and the other connected to the common voltage line Vcom. The second capacitor C2 may be substantially the same as the second capacitor C2 shown in FIG. 4.

In the above-described embodiments of the present invention shown in FIGS. 1 to 8, description has been made with regard to the liquid crystal display device of displaying a stereoscopic image, but aspects of the present invention are not limited thereto. When the present invention is applied to a liquid crystal display device capable of displaying a dual-view image, display quality and brightness of the dual-view image can be improved, like in the liquid crystal display device of displaying a stereoscopic image.

While the present invention has been particularly shown and described with reference to certain embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A liquid crystal display device comprising:
a liquid crystal panel including a gate line, a data line intersecting the gate line and a plurality of pixels, wherein each of the plurality of pixels comprises:
a transistor having a gate connected to the gate line, a source connected to the data line and a drain connected to a first node;
a switch having one end connected to the first node and another end connected to a second node;
a first capacitor having one end connected to the first node; and
a liquid crystal capacitor having one end connected to the second node.

2. The liquid crystal display device of claim 1, wherein the switches included in the plurality of pixels are configured to be simultaneously turned on.

3. The liquid crystal display device of claim 1, further comprising a driver that is configured to apply a gate signal to the gate line, to apply a data signal to the data line and to apply a first control signal to the switch.

4. The liquid crystal display device of claim 3, wherein the driver applying the data signal to the data line is configured to turn the switch into a turned-off state.

5. The liquid crystal display device of claim 3, wherein the gate signal includes a gate-on signal that turns on the transistor and a gate-off signal that turns off the transistor, and wherein the driver applying the gate-on signal to the gate line is configured to turn the switch into a turned-off state.

6. The liquid crystal display device of claim 5, wherein the gate line includes first to nth gate lines, the switch is configured to be turned on during a first writing period, the driver is configured to apply the gate-on signal to first to nth gate lines and the switch is configured to be turned off during a display period following the first writing period, and the switch is configured to be turned on during a second writing period following the first writing period.

7. The liquid crystal display device of claim 6, wherein the liquid crystal panel displays an image including a first frame and a second frame following the first frame, and during the writing period, the data signal corresponding to the first frame is stored in the liquid crystal capacitor and the data signal corresponding to the second frame is stored in the first capacitor.

8. The liquid crystal display device of claim 1, wherein the liquid crystal panel further comprises a common voltage line to which a common voltage is applied, and another end of the first capacitor and the other end of the liquid crystal capacitor are connected to the common voltage line.

9. The liquid crystal display device of claim 8, further comprising a second capacitor having one end connected to the second node and another end connected to the common voltage line.

10. A liquid crystal display device comprising:
a liquid crystal panel including a gate line, a data line intersecting the gate line, a common voltage line to which a common voltage is configured to be applied and a plurality of pixels, wherein each of the plurality of pixels comprises:
a transistor having a gate connected to the gate line, a source connected to the data line and a drain connected to a first node;
a first switch having one end connected to the first node and another end connected to a second node;
a first capacitor having one end connected to the first node;
a second switch having one end connected to the second node and another end connected to the common voltage line; and
a liquid crystal capacitor having one end connected to the second node.

11. The liquid crystal display device of claim 10, wherein the first switches included in the plurality of pixels are configured to be simultaneously turned on and off.

12. The liquid crystal display device of claim 10, wherein the second switches included in the plurality of pixels are configured to be simultaneously turned on and off.

13. The liquid crystal display device of claim 10, wherein during a black period, the second switch is configured to be in a turned-on state and the first switch is configured to be in a turned-off state, and during a writing period following the black period, the first switch is configured to be in a turned-on state and the second switch is configured to be in a turned-off state.

14. The liquid crystal display device of claim 10, further comprising a driver configured to apply a gate signal to the gate line, to apply a data signal to the data line, to generate a first control signal to control the first switch and to generate a second control signal to control the second switch.

15. The liquid crystal display device of claim 14, wherein the driver applying the data signal to the data line is configured to turn the first switch into an off state.

16. The liquid crystal display device of claim 14, wherein the gate signal includes a gate-on signal configured to turn on the transistor and a gate-off signal configured to turn off the transistor, wherein when driver applying the gate-on signal to the gate line is configured to turn the switch into an off state.

17. The liquid crystal display device of claim 16, wherein the first switch is configured to be turned on and the second switch is configured to be turned off during a first writing period, the driver is configured to apply the gate-on signal to first to nth gate lines and the first switch is configured to be turned off during a display period following the first writing period, the second switch is configured to be turned on during a black period following the first writing period, and the first switch is configured to be turned on and the second switch is configured to be turned off during a second writing period following the black period.

18. The liquid crystal display device of claim 17, wherein the liquid crystal panel displays an image including a first frame and a second frame following the first frame, and during the writing period, the data signal corresponding to the first frame is stored in the liquid crystal capacitor and the data signal corresponding to the second frame is stored in the first capacitor.

19. The liquid crystal display device of claim 10, wherein another end of the first capacitor and another end of the liquid crystal capacitor are connected to the common voltage line.

20. The liquid crystal display device of claim 10, further comprising a second capacitor having one end connected to the second node and another end connected to the common voltage line.
